(19) United States
(12) Patent Application Publication
(10) Pub. No.: US 2018/0109711 A1
(43) Pub. Date: Apr. 19, 2018

(54) METHOD AND DEVICE FOR OVEREXPOSED PHOTOGRAPHY

(71) Applicant: NUBIA TECHNOLOGY CO., LTD., NANSHAN DISTRICT SHENZHEN, GUANGDONG (CN)

(72) Inventors: LINWEN LIU, NANSHAN DISTRICT SHENZHEN, GUANGDONG (CN); XIAOHUI CUI, NANSHAN DISTRICT SHENZHEN, GUANGDONG (CN); LEI MIAO, NANSHAN DISTRICT SHENZHEN, GUANGDONG (CN); QIANG LI, NANSHAN DISTRICT SHENZHEN, GUANGDONG (CN)

(21) Appl. No.: 15/327,044

(22) PCT Filed: Jul. 6, 2015
(86) PCT No.: PCT/CN2015/083386

§ 371 Date: Mar. 24, 2017

(30) Foreign Application Priority Data
Jul. 24, 2014 (CN) 201410356986.6

(51) Int. Cl. H04N 5/235; H04N 5/355

(52) U.S. Cl. CPC H04N 5/2353; H04N 5/35536

(57) ABSTRACT

A method for overexposed photography is disclosed. The method includes: photographing an overexposed picture in which a target object is included with a preset overexposed photography parameter; acquiring image data of the target object from the overexposed picture; generating a composite picture according to the acquired image data of the target object with a preset standard overexposed picture as the background. The embodiment of the present invention further discloses an apparatus for overexposed photography. The embodiment of the present invention can realize to photograph a picture with a target object which is clear and is highlighted over background while only requiring to take one picture without the requirement of long time for the exposure photography, which is fast and highly efficient.

### CROSS-REFERENCE TO RELATED APPLICATION

This application is the 35 U.S.C. §371 national stage application of PCT Application No. PCT/CN2015/083386, filed Jul. 6, 2015, where the PCT claims priority to and the benefit of, CN Patent Application No. 201410356986.6, filed Jul. 24, 2014, both of which are herein incorporated by reference in their entirety.

### TECHNICAL FIELD

The present article relates to the field of photography technology, and in particular to an overexposure photography method and apparatus.

### BACKGROUND

When photographing a target object, due to the limitation of light in the environmental, the photographed picture may be very dark. For example, when photographing the starry sky, since it is photographed at night, the photographed starlight is very bleak with limitation of the light at night. The above problems can be solved through long time overexposed photography, which makes the target object that is required to be photographed more clearly and more highlighted over the background. However, there are still some problems in the long time overexposed photography, which limits the use of that photography method, for example, the consumed photographing time is longer, etc.

The above content is only used for assistantly understanding the technical scheme of the embodiment of the present invention, and does not mean admitting that the above content is the existing technology.

### SUMMARY OF THE INVENTION

The embodiment of the present invention provides a fast overexposure photography method, which can make the target object to be clearer and more prominent in the background when light in the environment is weak.

In order to solve the above technical problem, the embodiment of the present invention provides a method for overexposed photography, including:

photographing an overexposed picture in which a target object is included with a preset overexposed photography parameter;

acquiring image data of the target object from the overexposed picture; and

generating a composite picture according to the acquired image data of the target object with a preset standard exposed picture as a background.

Alternatively, herein, before the step of generating a composite picture according to the acquired image data of the target object with a preset standard exposed picture as a background, the method for overexposed photography further includes:

with a preset standard photographing parameter, photographing a standard exposed picture of the target object as the preset standard exposed picture.

Alternatively, herein, the step of acquiring image data of the target object from the overexposed picture includes:

acquiring a pixel parameter of each pixel in the overexposed picture; and

determining a pixel of which the acquired pixel satisfies a preset condition as a pixel of the target object, and acquiring position information of the pixel of the target object, and obtain the image data of the target object.

Alternatively, herein, the step of generating a composite picture according to the acquired image data of the target object with a preset standard exposed picture as the background includes:

replacing a pixel corresponding to the position information of the pixel of the target object in the preset standard exposed picture with the pixel of the target object.

Alternatively, the target object is one of the following: a star, a moon and lightning.

In order to solve the above technical problem, the embodiment of the present invention further provides an apparatus for overexposed photography, including:

a photographing module, arranged to: photograph an overexposed picture in which a target object is included with a preset overexposed photography parameter;

an acquiring module, arranged to: acquire image data of the target object from the overexposed picture; and

a composition module, arranged to generate a composite picture according to the acquired image data of the target object with a preset standard exposed picture as a background.

Alternatively, the apparatus for overexposed photography further includes:

a standard photographing module, arranged to: with a preset standard photographing parameter, photograph a standard exposed picture of the target object as the preset standard exposed picture.

Alternatively, herein, the acquiring module includes:

a first acquiring unit, arranged to: acquire a pixel parameter of each pixel in the overexposed picture; and

a second acquiring unit, arranged to: determine a pixel of which the acquired pixel parameter satisfies a preset condition as a pixel of the target object, and acquire position information of the pixel of the target object, obtain the image data of the target object.

Alternatively, herein, the composition module is arranged to:

replace a pixel corresponding to the position information of the pixel of the target object in the preset standard exposed picture with the pixel of the target object.

Alternatively, the target object is one of the following:

a star, a moon and lightning.

The embodiment of the present invention further provides a computer readable storage medium, storing a computer program, herein, the computer program includes program instructions, and when the program instructions are executed by a terminal device, the device is enabled to execute the above method for overexposed photography.

The embodiment of the present invention photographs an overexposed picture in which a target object is included with a preset overexposed photography parameter; acquires image data of the target object from the overexposed picture; and generates a composite picture according to the acquired image data of the target object with a preset standard exposed picture as the background. The embodiment of the present invention can realize to photograph a picture with a target object which is clear and is highlighted over the background while only requiring to take one picture without the requirement of long time for the exposure photography, which is fast and highly efficient. In addition, the embodiment of the present invention does not need to occupy the imaging equipment for a long time, and consumes less resources of the imaging equipment, and is convenient for the user to use.

### BRIEF DESCRIPTION OF DRAWINGS

FIG. 1 is a flow chart of a method for overexposed photography in a first embodiment of the present invention;

FIG. 2 is a flow chart of a method for overexposed photography in a second embodiment of the present invention;

FIG. 3 is a flow chart of a method for overexposed photography in a third embodiment of the present invention;

FIG. 4 is a diagram of functional modules of an apparatus for overexposed photography in a first embodiment of the present invention;

FIG. 5 is a diagram of functional modules of an apparatus for overexposed photography in a second embodiment of the present invention; and

FIG. 6 is a diagram of functional modules of an apparatus for overexposed photography in a third embodiment of the present invention.

### PREFERRED EMBODIMENTS OF THE PRESENT INVENTION

The embodiment of the present invention will be described in details by combining with the accompanying drawings. It should be illustrated that, in the case of not conflicting, the embodiments in the present application and features in these embodiments can be combined with each other at will. In addition, although the logic sequence is shown in the flow chart, in some cases, the shown or described steps can be executed by a sequence different from here.

It should be understood that the specific embodiments described herein are only used for interpreting the present invention and are not intended to limit the present invention.

Those skilled in the art can understand that in the following embodiments of the method for overexposed photography of the present invention, the subject of implementing the method for overexposed photography of the embodiment of the present invention can be terminals, such as, a mobile phone, a tablet computer, a camera, a video camera and so on, and can also be any of terminal or apparatus which can realize the method for overexposed photography of the embodiment of the present invention, which is not limited by the present invention. In the following embodiments of the method for overexposed photography of the present invention, alternatively, a mobile phone is used as the implementation object for the method for overexposed photography in the embodiment of the present invention. In addition, the target object mentioned in the following embodiments of the method and apparatus for overexposed photography in the present invention can be an object, a human and an animal, etc. which is not limited by the present invention.

The embodiment of the present invention discloses a method for overexposed photography.

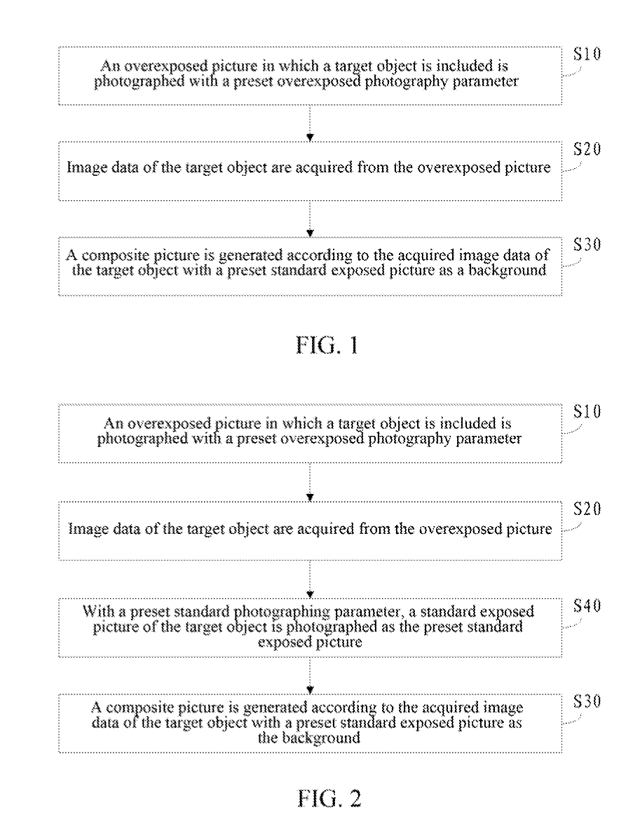

Referring to FIG. 1, FIG. 1 is a flow chart of a method for overexposed photography in a first embodiment of the present invention.

In the first embodiment of the method for overexposed photography, the method includes the following steps.

In step S10, an overexposed picture in which a target object is included is photographed with a preset overexposed photography parameter;

the overexposed photography parameter can be preset by the user or the mobile phone, and the overexposed photography parameter includes an exposure time. For example, a range of values for the exposure time is set as 30 seconds to 2 minutes.

Because the ingested light amount required by the overexposed is larger, when the environment light is weak, the overexposed picture enables the brightness of the photographed target object (such as, the star, the moon, the lightning, etc.) be increased and the target object be better highlighted.

The method for photographing the overexposed picture of the target object and photographing the preset standard exposed picture of the target object can be: the mobile phone automatically configuring an exposure value according to the brightness of the environment to make the photographed picture present an overexposed effect; or, the user annually configuring the exposure value to make the photographed picture present the overexposed effect;

The above method for configuring the exposure value can be: adjusting the exposure value through setting a shutter value and an aperture value.

In step S20, image data of the target object are acquired from the above overexposed picture;

the step of the mobile phone acquiring the image data of the target object from the overexposed picture can be: segmenting the target object and the background in the overexposed picture through a mode of setting the color threshold, to obtain the image data of the target object; or, segmenting the target object and the background in the overexposed picture through an area segmentation mode (such as, area growing, area splitting and merging and other area segmentation modes), to obtain the image data of the target object; or, segmenting the target object and the background in the overexposed picture through edge detection (for example, identifying a color value or grayscale grade or a position of structure change as an edge), to obtain the image data of the target object. In addition, the segmentation of the target object and the background can further be achieved by a mode of cluster analysis, etc., to obtain the image data of the target object. Herein, all the modes, such as, area segmentation, edge detection, clustering analysis, etc., have a more mature algorithm to support.

Herein, the image data of the target object can be distribution of the pixels forming the target object, distribution of the color, distribution of the brightness value, and so on; or, the image data of the target object may also be a picture fragment only including the target object.

In step S30, a composite picture is generated according to the acquired image data of the target object with a preset standard exposed picture as the background.

The preset standard exposed picture can be a picture preset by the user or the mobile phone.

The step for the mobile phone to generate the composite picture can be that: the image data of the target object only include the picture fragment of the target object; the picture fragment of the target object is used as the top layer, the preset standard exposed picture is used as the bottom layer, and both are overlaid and combined to generate a composite picture; or, the image data of the target object are the pixel information composed of the target object, and the pixel at the corresponding position in the preset standard exposed picture is replaced as the pixel composed of the target object, to generate the composite picture.

The present embodiment can realize to photograph a picture with a target object which is clear and is highlighted over background while only requiring to take one picture without the requirement of long time for exposure photography, which is fast and highly efficient. In addition, the present embodiment does not need to occupy the imaging equipment for a long time, and consumes less resources of the imaging equipment, and is convenient for the user to use.

In the present embodiment, after the step S30, the method for overexposed photography also includes:

when there are multiple composite pictures, performing encoding process on multiple composite pictures; and

generating a video file according to the multiple composite pictures on which the encoding process are performed.

The present embodiment can generate a dynamic video file according to the multiple composite pictures; if there is a relative displacement between the photographed target object and the mobile phone, the moving process of the target object can be presented by the video file, to meet the individual requirement of the user.

Referring to FIG. 2, FIG. 2 is a flow chart of a method for overexposed photography in a second embodiment of the present invention.

In the second embodiment of the method for overexposed photography of the present invention, based on the first embodiment, before the step S10, or step S20 or step S30, the method of the present embodiment further includes the following steps.

In step S40, with a preset standard photographing parameter, a standard exposed picture of the target object is photographed as the preset standard exposed picture.

The standard photographing parameter includes the exposure time. For example, a range of values for the exposure time is set within 1 second.

The user can photograph the overexposed picture and the preset standard exposed picture at the same time; or first photograph the overexposed picture and then photograph the preset standard exposed picture; or first photograph the preset standard exposed picture and then photograph the overexposed picture; or, photograph one or more overexposed pictures, and correspondingly photograph one preset standard exposed picture, etc. The user or the mobile phone can also set a preset rule according to the requirements, which is not limited by the present invention.

The present embodiment photographs the standard exposed picture as the preset standard exposed picture, which makes the generated picture more realistic.

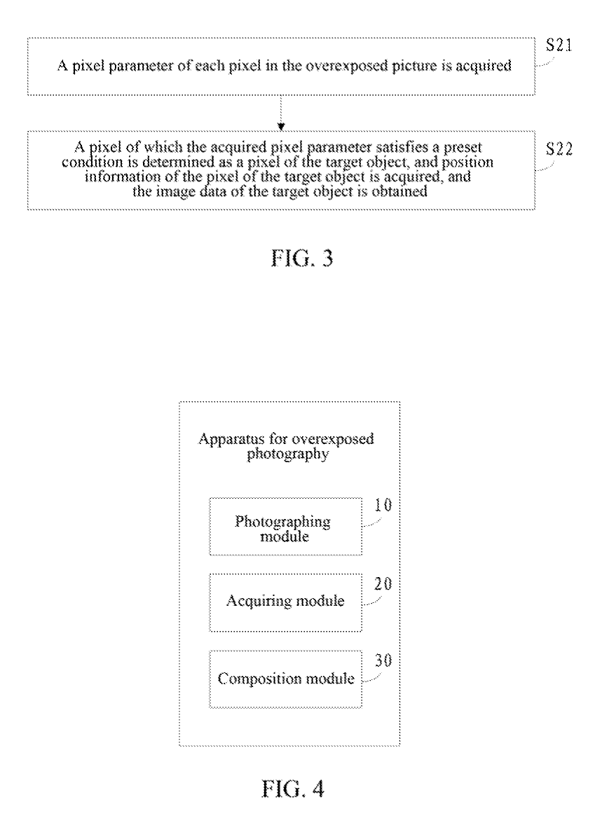

Referring to FIG. 3, FIG. 3 is a flow chart of a method for overexposed photography in a third embodiment of the present invention.

In the third embodiment of the method for overexposed photography of the present invention, based on the first embodiment and the second embodiment, the step S20 of the present embodiment includes the following.

In step S21, a pixel parameter of each pixel in the overexposed picture is acquired;

the pixel parameter can be set according to the setting of the user or the mobile phone, and at least include one of the following:

a color value, brightness, a tone value, saturation, etc.

Of course, according to the setting of the user or the mobile phone, other parameters also can be used as the pixel parameters.

In step S22, a pixel of which the acquired pixel parameter satisfies a preset condition is determined as a pixel of the target object, and position information of the pixel of the target object is acquired and the image data of the target object is obtained.

The pixel of the target is the pixel composed of the target object in the overexposed picture.

The preset condition is preset by the user or the mobile phone.

The step for determining the pixel in the overexposed picture as the pixel of the target object is illustrated by an example hereinafter; and it should be noted that the following example is only used to help understanding and is not used to limit the scope of the present invention.

For example, the preset condition is that the color value of the pixel is in a preset range of the color value, and the brightness value of the pixel is greater than a preset brightness value. If both the color value and the brightness value of one pixel in the overexposed picture are satisfied with the above condition, then the pixel is determined as the pixel of the target object. The user or the mobile phone can also further set the preset condition as that a difference between the brightness value of the pixel and an average value of the brightness values of the adjacent pixels is less than a preset value, and the condition may exclude the situation that the pixel is a noise point.

The position information of the pixel of the target object can be the information, such as, the number of the pixel, or the number of the row and the column where the pixel is located, or a coordinate value, etc., which can indicate the position of the pixel in the overexposed picture. It is different to acquire the position information of the pixel of the target object with the existing technology, and will not be repeated here.

The determined pixel of the target object and the acquired position information of the pixel of the target object are the image data of the target object.

The present embodiment can accurately and fast segment the target object and the background in the overexposed picture, and obtain the image data of the target object.

In the fourth embodiment of the method for overexposed photography of the present invention, based on the first embodiment and the third embodiment, the step S30 of the present embodiment includes the following:

replacing a pixel corresponding to the position information of the pixel of the target object in the preset standard exposed picture with the pixel of the target object.

The mobile phone finds the pixel required to be replaced in the preset standard exposed picture according to the position information of the pixel of the target object, and replace the pixel required to be replaced in the preset standard exposed picture with the pixel of the target object, and the composite picture is obtained after all pixels of the target object are replaced into the preset standard exposed picture.

The overexposed photography increases the brightness of the photographed target object; therefore, the pixels of the target object are replaced to the preset standard exposed picture, and the target object can be better highlighted in the composite picture which takes the preset standard exposed picture as the background. For example, if the target object is in the star, then the star light appears more bright and shining in the preset standard exposed picture in the composite picture. On the other hand, for the star which is relatively far from the earth, even if the star light is very weak, the overexposed photography can also photograph it; and its pixels are replaced into the preset standard exposed picture to obtain the composite picture which is a nebula picture, and the number of stars in the composite picture is far more than that of the nebula picture photographed by normal photography method.

Alternatively, in a alternative embodiment of the present invention, before the step S20, the method further includes:

pre-processing the overexposed picture.

The pre-processing modes can include sharpening processing, morphological processing, noise reduction processing, etc.

Herein, the sharpening processing can improve the clarity of the target object in the overexposed image, and make the edge area of the target object more clearly; the morphological processing can make the edge of the line in the overexposed picture more smooth; and the noise reduction processing can filter the noise information in the overexposed image, and improve the signal to noise ratio of the overexposed image.

The present embodiment pre-processes the overexposed picture, makes the edge of the target object more clearly, and is conducive to improve the accuracy of acquiring the image data of the target object.

Alternatively, in the fifth embodiment of the method for overexposed photography of the present invention, based on the first embodiment, the second embodiment the third embodiment and the fourth embodiment, the target object of the present embodiment includes the following:

a star, a moon and lightning, etc.

The embodiment of the present invention further provides an apparatus for overexposed photography, which includes a processor and a program storage device.

Referring to FIG. 4, FIG. 4 is a diagram of functional modules of an apparatus for overexposed photography in a first embodiment of the present invention.

In the first embodiment of the apparatus for overexposed photography, the apparatus includes:

a photographing module 10, arranged to: photograph an overexposed picture in which a target object is included with a preset overexposed photography parameter;

an acquiring module 20, arranged to: acquire image data of the target object from the overexposed picture; and

a composition module 30, arranged to generate a composite picture according to the acquired image data of the target object with a preset standard exposed picture as the background.

The overexposed photography parameter can be preset by the user or an apparatus for overexposed photography, and the overexposed photography parameter includes an exposure time. For example, a range of values for the exposure time is set as 30 seconds to 2 minutes.

Because the ingested light amount is larger, when the light in the environment is weak, the overexposed picture enables the brightness of the photographed target object (such as, the star, the moon, the lightning, etc.) be increased and the target object be better highlighted.

The step for photographing the overexposed picture of the target object and photographing the preset standard exposed picture of the target object can be: the photographing module 10 automatically configuring an exposure value according to the brightness of the environment to make the photographed picture present an overexposed effect; or, the user annually configuring the exposure value to make the photographed picture present the overexposed effect.

The above step for configuring the exposure value can be: adjusting the exposure value through setting a shutter value and an aperture value.

The step of the acquiring module 20 acquiring the image data of the target object from the overexposed picture can be: segmenting the target object and the background in the overexposed picture through a mode of setting the color threshold, to obtain the image data of the target object; or, segmenting the target object and the background in the overexposed picture through an area segmentation method (such as, area growing, area splitting and merging and other area segmentation modes), to obtain the image data of the target object; or, segmenting the target object and the background in the overexposed picture through edge detection (for example, identifying a color value or grayscale grade or a position of structure change as an edge), to obtain the image data of the target object; and in addition, the segmentation of the target object and the background can further be achieved by a mode of clustering analysis, etc., to obtain the image data of the target object. Herein, all the modes, such as, area segmentation, edge detection, clustering analysis, etc., have a more mature algorithm to support.

Herein, the image data of the target object can be distribution of the pixels forming the target object, distribution of the color, distribution of the brightness value, and so on; or, the image data of the target object may also be a picture fragment only including the target object.

The preset standard exposed picture can be a picture preset by the user or the apparatus for overexposed photography.

The step for the composition module 30 to generate the composition picture can be that: the image data of the target object only include the picture fragment of the target object; the picture fragment of the target object is used as the top layer, the preset standard exposed picture is used as the bottom layer, and both are overlaid and combined to generate a composite picture; or, the image data of the target object are the pixel information composed of the target object, and the pixel at the corresponding position in the preset standard exposed picture is replaced as the pixel composed of the target object, to generate the composite picture.

The present embodiment can realize to photograph a picture with a target object which is clear and is highlighted over background while only requiring to take one photograph without the requirement of long time for the exposure photography, which is fast and highly efficient. In addition, the embodiment of the present invention does not need to occupy the mobile phone for a long time, and consumes less resources of the mobile phone, and is convenient for the user to use.

In the present embodiment, the apparatus for overexposed photography further includes a video module (not shown in the figure), and the video module is applied to:

when there are multiple composite pictures, perform an encoding process on multiple composite pictures; and

generate a video file according to the multiple composite pictures on which the encoding process is performed.

The present embodiment can generate a dynamic video file according to the multiple composite pictures; if there is a relative displacement between the photographed target object and the mobile phone, the moving process of the target object can be presented by the video file, to meet the individual requirement of the user.

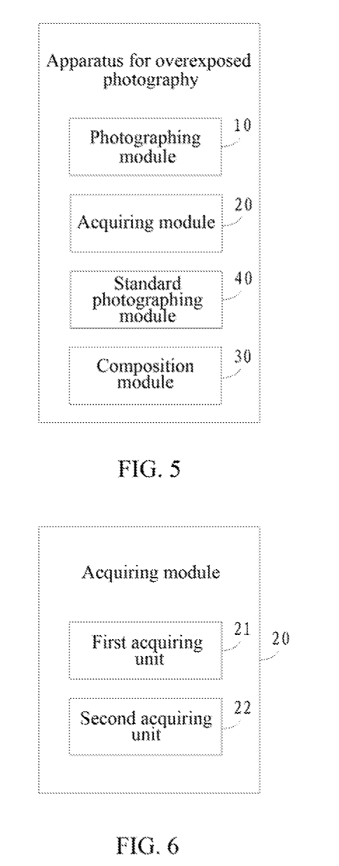

Referring to FIG. 5, FIG. 5 is a diagram of functional modules of an apparatus for overexposed photography in a second embodiment of the present invention.

In the second embodiment of the apparatus for overexposed photography of the present invention, based on the first embodiment, the apparatus for overexposed photography of the present embodiment further includes:

a standard photographing module 40, arranged to: with a preset standard photographing parameter, photograph a standard exposed picture of the target object as the preset standard exposed picture.

The standard photographing parameter includes the exposure time. For example, a range of values for the exposure time is set within 1 second.

The user can photograph the overexposed picture and the preset standard exposed picture at the same time; or first photograph the overexposed picture and then photograph the preset standard exposed picture; or first photograph the preset standard exposed picture and then photograph the overexposed picture; or, photograph one or more overexposed pictures, and correspondingly photograph one preset standard exposed picture, etc. The user or the mobile phone can also set a preset rule according to the requirements, which is not limited by the present invention.

The present embodiment photographs the standard exposed picture as the preset standard exposed picture, which makes the generated picture more realistic.

Referring to FIG. 6, FIG. 6 is a diagram of functional modules of an apparatus for overexposed photography in a third embodiment of the present invention.

In the third embodiment of the apparatus for overexposed photography of the present invention, based on the first embodiment and the second embodiment, the acquiring module 20 of the present embodiment includes:

a first acquiring unit 21, arranged to: acquire a pixel parameter of each pixel in the overexposed picture; and

a second acquiring unit 22, arranged to: determine a pixel of which the acquired pixel parameter satisfies a preset condition as a pixel of the target object, and acquire position information of the pixel of the target object to obtain the image data of the target object.

The pixel parameter can be set according to the setting of the user or the first acquiring unit 21, and at least include one of the following:

A color value, brightness, a tone value, saturation, etc.

Of course, according to the setting of the user or the first acquiring unit 21, other parameters also can be used as the pixel parameters.

The pixel of the target is the pixel composed of the target object in the overexposed picture.

The preset condition is preset by the user or the second acquiring unit 22.

The step for determining the pixel in the overexposed picture as the pixel of the target object is illustrated by an example hereinafter; and it should be noted that the following example is only used to help understanding and is not used to limit the scope of the present invention.

For example, the preset condition is that the color value of the pixel is in a preset range of the color value, and the brightness value of the pixel is greater than a preset brightness value. If both the color value and the brightness value of one pixel in the overexposed picture are satisfied with the above condition, then the pixel is determined as the pixel of the target object. The user or the second acquiring unit 22 can also further set the preset condition as that a difference between the brightness value of the pixel and an average value of the brightness values of the adjacent pixels is less than a preset value, and the condition may exclude the situation that the pixel is a noise point.

The position information of the pixel of the target object can be the information, such as, the number of the pixel, or the number of the row and the column where the pixel is located, or a coordinate value, etc., which can indicate the position of the pixel in the overexposed picture. It is different to acquire the position information of the pixel of the target object with the existing technology, and will not be repeated here.

The determined pixel of the target object and the acquired position information of the pixel of the target object are the image data of the target object.

The present embodiment can accurately and fast segment the target object and the background in the overexposed picture, and obtain the image data of the target object.

In the fourth embodiment of the apparatus for overexposed photography of the present invention, based on the third embodiment, the composition module 30 of the present embodiment is further arranged to:

replace a pixel corresponding to the position information of the pixel of the target object in the preset standard exposed picture with the pixel of the target object.

The composition module 30 finds the pixel required to be replaced in the preset standard exposed picture according to the position information of the pixel of the target object, and replace the pixel required to be replaced in the preset standard exposed picture with the pixel of the target object, and the composite picture is obtained after all pixels of the target object are replaced into the preset standard exposed picture.

The overexposed photography increases the brightness of the photographed target object; therefore, the pixels of the target object are replaced to the preset standard exposed picture, and the target object can be better highlighted in the composite picture which takes the preset standard exposed picture as the background. For example, if the target object is a star, then the star light appears more bright and shining in the preset standard exposed picture in the composite picture. On the other hand, for the star which is relatively far from the earth, even if the star light is very weak, the overexposed photography can also photograph it; and its pixels are replaced into the preset standard exposed picture to obtain the composite picture which is a nebula picture and the number of stars in the composite picture is far more than that of the nebula picture photographed by normal photography method.

Alternatively, in an alternative embodiment of the present invention, the apparatus for overexposed photography includes:

a pre-processing module (not shown in the figure), which suitable for pre-processing the overexposed picture.

The pre-processing modes can include sharpening processing, morphological processing, noise reduction processing, etc.

Herein, the sharpening processing can improve the clarity of the target object in the overexposed image, and make the edge area of the target object more clearly; the morphological processing can make the edge of the line in the overexposed picture more smooth; and the noise reduction processing can filter the noise information in the overexposed image, and improve the signal to noise ratio of the overexposed image.

The present embodiment pre-processes the overexposed picture, makes the edge of the target object more clearly, and is conducive to improve the accuracy of acquiring the image data of the target object.

Alternatively, in the fifth embodiment of the apparatus for overexposed photography of the present invention, based on the first embodiment, the second embodiment the third embodiment and the fourth embodiment, the target object of the present embodiment includes the following:

a star, a moon and lightning, etc.

It can be understood by those skilled in the art that all or part of steps in the above-mentioned method can be fulfilled by programs instructing the relevant hardware components, and the programs can be stored in a computer readable storage medium such as a read only memory, a magnetic disk or an optical disk, etc. Alternatively, all or part of the steps in the above-mentioned embodiments can be implemented with one or more integrated circuits. Accordingly, each module/unit in the above-mentioned embodiments can be implemented in the form of hardware, or in the form of software function module. The present invention is not limit to any specific form of the combination of the hardware and software.

Of course, the present invention can have a variety of other embodiments. Those skilled in the art can make the corresponding modifications and variations according to the present invention without departing from the spirit and essence of the present invention. And all of these modifications or the variations should be embodied in the scope of the appending claims of the present invention.

### INDUSTRIAL APPLICABILITY

The method for overexposed photography provided by the embodiment of the present invention can realize to photograph a picture with a target object which is clear and is highlighted over background while only requiring to take one picture without the requirement of long-exposure photography, which is fast and highly efficient, and it does not need to occupy the imaging equipment for a long time, and consumes less resources of the imaging equipment, and is convenient for the user to use.

1. A method for overexposed photography, comprising:
photographing an overexposed picture in which a target object is comprised with a preset overexposed photography parameter;
acquiring image data of the target object from the overexposed picture; and
generating a composite picture according to the acquired image data of the target object with a preset standard exposed picture as a background.

2. The method according to claim 1, wherein, before the step of generating a composite picture according to the acquired image data of the target object with a preset standard exposed picture as a background, further comprising:
with a preset standard photographing parameter, photographing a standard exposed picture of the target object as the preset standard exposed picture.

3. The method according to claim 1, wherein, the step of acquiring image data of the target object from the overexposed picture comprises:
acquiring a pixel parameter of each pixel in the overexposed picture; and
determining a pixel of which the acquired pixel parameter satisfies a preset condition as a pixel of the target object, acquiring position information of the pixel of the target object, and obtaining the image data of the target object.

4. The method according to claim 3, wherein, the step of generating a composite picture according to the acquired image data of the target object with a preset standard exposed picture as a background comprises:
replacing a pixel corresponding to the position information of the pixel of the target object in the preset standard exposed picture with the pixel of the target object.

5. The method according to claim 1, wherein, the target object is one of the following: a star, a moon and lightning.

6. An apparatus for overexposed photography, comprising:
a photographing module, arranged to: photograph an overexposed picture in which a target object is comprised with a preset overexposed photography parameter;
an acquiring module, arranged to: acquire image data of the target object from the overexposed picture; and
a composition module, arranged to generate a composite picture according to the acquired image data of the target object with a preset standard exposed picture as a background.

7. The apparatus according to claim 6, further comprising:
a standard photographing module, arranged to: with a preset standard photographing parameter, photograph a standard exposed picture of the target object as the preset standard exposed picture.

8. The apparatus according to claim 6, wherein, the acquiring module comprises:
a first acquiring unit, arranged to: acquire a pixel parameter of each pixel in the overexposed picture; and
a second acquiring unit, arranged to: determine a pixel of which the acquired pixel parameter satisfies a preset condition as a pixel of the target object, acquire position information of the pixel of the target object, and obtain the image data of the target object.

9. The apparatus according to claim 8, wherein, the composition module is arranged to:
replace a pixel corresponding to the position information of the pixel of the target object in the preset standard exposed picture with the pixel of the target object.

10. The apparatus according to claim 6, wherein, the target object is one of the following:
a star, a moon and lightning.

11. A computer readable storage medium, storing a computer program, wherein, the computer program comprises program instructions, and when the program instructions are executed by a terminal device, the device is enabled to execute the method in claim 1.

12. The method according to claim 2, wherein, the step of acquiring image data of the target object from the overexposed picture comprises:
acquiring a pixel parameter of each pixel in the overexposed picture; and
determining a pixel of which the acquired pixel parameter satisfies a preset condition as a pixel of the target object, acquiring position information of the pixel of the target object, and obtaining the image data of the target object.

13. The method according to claim 2, wherein, the target object is one of the following: a star, a moon and lightning.

14. The method according to claim 4, wherein, the target object is one of the following: a star, a moon and lightning.

15. The apparatus according to claim 7, wherein, the acquiring module comprises:
a first acquiring unit, arranged to: acquire a pixel parameter of each pixel in the overexposed picture; and
a second acquiring unit, arranged to: determine a pixel of which the acquired pixel parameter satisfies a preset condition as a pixel of the target object, acquire position information of the pixel of the target object, and obtain the image data of the target object.

16. The apparatus according to claim 7, wherein, the target object is one of the following:
a star, a moon and lightning.

17. The apparatus according to 9, wherein, the target object is one of the following:
a star, a moon and lightning.
